(19) United States
(12) Patent Application Publication
(10) Pub. No.: US 2006/0009159 A1
(43) Pub. Date: Jan. 12, 2006

(54) Protocol layer analysis in mobile device testing

(76) Inventor: Hung Fung Leung, Kowloon (HK)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/887,727

(22) Filed: Jul. 9, 2004

(51) Int. Cl. H04B 17/00

(52) U.S. Cl. 455/67.11; 455/115.1

(57) ABSTRACT

Embodiments of the present invention test the quality of data transfer between wireless devices by monitoring the performance of the protocol layers used by those devices. Some embodiments of the present invention measure the rate at which data is successfully transferred by the individual protocol layers of the device, and display these rates in real time using a graphic user interface (GUI). This real time GUI can then used by designers to investigate the efficiency of various wireless device designs.

### TECHNICAL FIELD

The present invention is directed to the testing of mobile devices, and more particularly towards the analysis of protocol layer performance during data transfer.

### BACKGROUND OF THE INVENTION

Modern mobile devices are capable of transferring an increasing variety of data types, and those types continue to grow in complexity. In order handle the transfer of these ever more complex data types, designers must continue to design and test more sophisticated mobile devices. For example, cellular telephones, once the transmitters and receivers of simple voice data, are now capable of playing and sending music, capturing and transmitting photographic images, and even recording and sending video. As the designs of these devices grow more intricate, it becomes increasingly important to be able to test the performance of each aspect involved in data transfer.

Designers of mobile devices typically test the efficiency of data transfers by using testers that can simulate the wireless networks the devices normally use. A tester for mobile telephones, for example, may simulate a mobile telephone network by receiving data from a telephone under test and translating that data into internet protocol (IP) for transmission to an IP network or a second tester. An IP network may be used when testing only one device. When a second tester is used, the second tester can simulate the wireless network of a destination telephone by translating the data received from the first tester into a format suitable for transmission to the destination mobile telephone. How well one mobile telephone transmits data to a second mobile telephone is typically determined by monitoring the IP format data stream as it passed between the two testers. Monitoring this through-put under a variety of conditions allows the designers to see how well different device configurations perform.

Many different phenomena and environmental conditions can effect the data transfer. For example, the rate of data transmitted by mobile telephones can be affected by weather conditions, physical obstacles along the transmission path, the type of data being transmitted, the physical attributes of the device, loss of signal, or other like conditions. Measuring the through-put between testers provides a measure of how well a tested device design as a whole performs under the conditions. However, this provides limited insight into how well the various aspects of the mobile device are performing individually.

Within the devices themselves, the transfer of data is typically achieved within the context of a layered architecture. In a layered framework, data is transferred from a source to a destination by passing through a succession of stacked layers, referred to as protocols. Each protocol layer accepts data from the one above it, alters the data appropriately, and then passes it to the next protocol layer in the stack. A typical mobile device will have a plurality of protocol layers responsible for transforming a data file from a form generated by an application into a form suitable for transmission. These same protocols will act in reverse to transform a received data file into a form suitable for use by an application. A mobile telephone, for example, will capture a data file, such as a video file, using a camera application. The video file will then be passed through a succession of protocol layers until it is in a format suitable for transmission to a tester or other device (typically via radio frequency). The typical methods of measuring the through-put between testers can measure the real time performance of this protocol stack as a whole, but it does not provide real-time information on how well each layer in the stack is performing individually.

### BRIEF SUMMARY OF THE INVENTION

Embodiments of the present invention test the quality of data transfer between wireless devices by monitoring the performance of the protocol layers used by those devices. Some embodiments of the present invention measure the rate at which data is successfully transferred by the individual protocol layers of the device, and then display those rates in real time using a graphic user interface (GUI). This real time GUI can then used by designers to investigate the efficiency of various wireless device designs.

Systems arranged in accordance with the present invention may include a first tester in communication with a first device and a second tester in communication with a second device, where data is transferred between the two testers using an internet protocol. In one such embodiment, each tester incorporates a processor capable of analyzing the data transmitted by their associated wireless device. Each processor may then determine the data transfer rate of the individual protocol layers within their respective device. Such a system could then display these transfer rates in real time in order to provide an analysis of how data is transferred from the capturing application of the first device to the presenting application on the second device.

One such embodiment uses a tester, arranged in accordance with the present invention, that simulates a wireless network typically used by a mobile telephone. When an application, such as a camera feature, of the mobile telephone captures data, the captured data is passed through the telephone's protocol layers, and wirelessly transmitted to the tester. At least one analysis module within the tester measures the rate at which each protocol layer successfully transfers the data and displays those rates on a monitor. The designer of the telephone can then use these measurements to analyze how well the telephone design performs under different conditions.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates a data transfer test system arranged according to an embodiment of the present invention;

FIG. 2 illustrates example measurements taken using an embodiment the present invention;

FIG. 3 illustrates example measurements taken using an alternative embodiment of the present invention; and

FIG. 4 is a tester arranged according to an embodiment of the present invention.

### DETAILED DESCRIPTION OF THE INVENTION

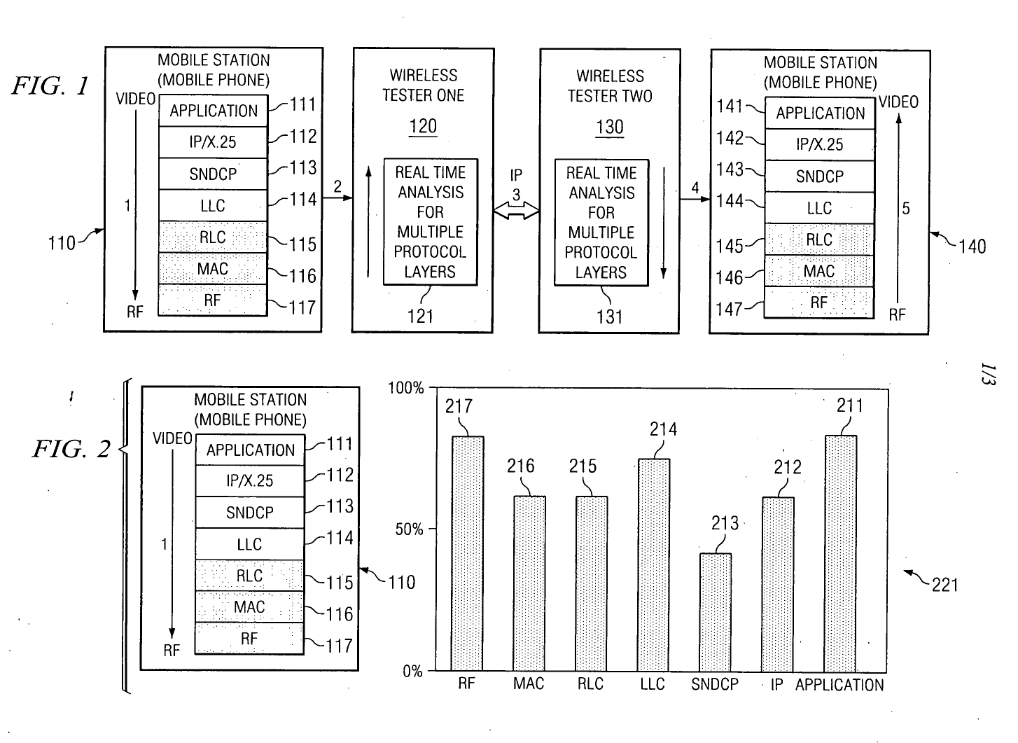

FIG. 1 illustrates a system, arranged according to an embodiment of the present invention, that is capable of testing the transmission of data between two wireless devices. In the embodiment of FIG. 1, wireless device 110 is a source device that is transmitting data to a destination wireless device 140. In normal use, devices 110 and 140 would be in communication with wireless networks and data would be passed between them via those networks. During testing, however, devices known as testers are typically used to simulate the wireless networks and provide information to the designers that aide in the evaluation of the devices being tested.

In order to test a device design, data is typical captured by a device, such as source device 110, and transmitted to a source device tester, such as tester 120. Source device tester 120 will then simulate a wireless network, such as the one used by source device 110 during normal operation, by receiving the transmitted data from source device 110 and preparing the data for transmission to a destination tester via an internet protocol (IP). The destination device tester 130 is used to simulate the wireless network used by destination mobile device 140 during normal operation, and prepares the data received from source tester 120 for transmission, via RF, to destination device 140. Typical testing systems will determine the efficiency of data transfer between device 110 and device 140 by measuring the data transfer rate between tester 120 and tester 130. But such measurements do not provide insight into the efficiency of the individual layers of devices 110 and 140.

Typical wireless networks will contain some type of base station sub-system (BSS), some type of Gateway GPRS (general packet radio service) Support Node (GGSN), and/or some type of Serving GPRS Support Node (SGSN). To simulate wireless networks, testers 120 and 130 will typically simulate portions of each of these features, but the manner of such simulation, and the particular portions simulated, will depend on the device tested. The embodiments of the present invention are not limited to any particular manner of network simulation.

Typically, devices capable of capturing data and transmitting that data to a destination do so by passing that data through a number of protocol layers. In the example embodiment of FIG. 1, source device 110 utilizes six such layers, but the protocol layers depicted in FIG. 1 are merely an example protocol stack. Embodiments of the present invention are not limited to the number or types of protocols listed, but rather can use any appropriate protocol stack. The example of FIG. 1 captures data using application layer 111 in source device 110. The data captured could be any form of user data that is to be transferred, such as HTML, graphics, email, voice, video, and/or any other type of user data. Once the data is captured, application layer 111 passes that data to IP/X.25 layer 112 which facilitates exchange between device 110 and the destination point within the network. IP/X.25 layer 112 passes the data to Sub Network Dependant Convergence Protocol (SNDC) layer 113 which provides a reliable link between mobile device 110 and the SGSN portions simulated by tester 120. SNDC layer 113 passes the data to Logical Link Control (LLC) layer 114 which also provides a reliable connection between the mobile device and the simulated portions of a SGSN. LLC layer 114 passes the data to Radio Link Control (RLC) layer 115 which provides a reliable radio link between the mobile device and the simulated portions of BSS. LLC layer 14 operates above RLC layer 115 so that GPRS can be provided on different radio systems. RLC layer 115 passes the data to Medium Access Control (MAC) layer 116 which enables multiple mobile devices to share a common resource on the GPRS air interface, while helping to avoid data collisions when those devices share the same timeslot. MAC layer 116 passes the data to Radio Frequency Network Service (RF) layer 117 which prepares the data for radio frequency transmission to tester 120.

Each layer must translate the data into a form appropriate for the layer directly following. Inherent to this translation is an error rate associated with conditions such as environmental conditions, internal connections, software errors, protocol stack overflow, limited processing power of the mobile CPU (central processing unit), and/or other like factors. Because each layer will be effected by the above factors differently, each of these layers may pass the data through at a different rate.

Tester 120 receives the data in the form of an RF signal, and simulates the kind of wireless network that source device 110 would use during normal operation. This simulation is achieved in part by translating the data received from source device 110 into a format suitable for transmission to destination tester 130. Typically, a tester will use an IP format and transmit that data over a local are network (LAN) connection, however, other format types and/or connection types may be used. Traditional methods of testing measure the data transfer rate through-put of the LAN transmission between testers. The embodiment of the present invention depicted in FIG. 1 includes analysis module 121 which is capable of measuring some characteristic of data flow in the individual protocol layers. This characteristic may be, for example, total data throughput, successful pass rate for data, a failed pass rate for data, and/or any other like characteristic. The example embodiment depicted measures the rate that each of the protocol layers 111-117 successfully passes packets of data, but embodiments are not limited to this characteristic. When the traditional methods measure the data transfer rate at the IP transmission stage, designers are only provided with knowledge of how the protocol stack performs as a whole. By providing information about the individual layers of the stack, embodiments of the present invention can better aide designers in investigating the specific performance of a device design.

Destination tester 130 simulates a wireless network that would typically be used by destination device 140 during normal operation. This simulation is achieved in part by translating the data received from source tester 130 into a format suitable for RF transmission. The data is received by destination device 140, where it passes through (in reverse) a protocol stack similar to that of source device 110. Destination device 140 is not limited to the specific protocol layers depicted in FIG. 1, but rather may utilize any appropriate protocol stack. In the depicted example embodiment, RF layer 147 receives the data as a radio frequency transmission from destination tester 130 and passes the data through in a format appropriate for MAC layer 146. Mac layer 146 translates the data and passes it to RLC layer 145. RLC layer 145 translates the data and passes it to LLC layer 144. LLC layer 144 translates the data and passes it to SNDCP layer 143. SNDCP layer 143 translates the data and passes it to IP/X.25 layer 142. IP/X.25 layer 142 translates the data and passes it to Application layer 141. Application layer 141 translates the data back into a format suitable for presenting the data on destination device 140. To test the efficiency of the protocol stack of device 140, tester 130 includes analysis module 131. Similar to analysis module 121, analysis module 131 is capable of measuring one or more characteristics, such as the successful transfer rate of data, through each layer of the protocol stack. This information can then be used by designers of such devices to analyze the performance of the design of device 140.

System 100 is additionally capable of two-way communication. Thus destination device 140 is capable of capturing data and transmitting it to source device 110. The process of this transmission in the depicted embodiment is merely the reverse of the process described above with destination device 140 acting as the source device, destination tester 130 acting as the source tester, source tester 120 acting as the destination tester, and source device 110 acting as the destination device.

It will be appreciated, that embodiments of the present invention are not limited to the example embodiment depicted in FIG. 1. The type of data transferred by a embodiments may any type of data capable of being captured by a wireless device. Embodiments may, for example, test the transfer of voice data, video data, text data, uploaded file data, or the like. Nor are the source device and destination device of the embodiments limited to a specific type of device, but rather may be any combination of cellular telephones, pagers, personal digital assistants (PDA's), walkie-talkies, or any wireless device that acquires data and passes it through a plurality of protocol layers. Nor are embodiments limited to using any specific protocol layer or stack of layers. It will be appreciated that the type and number of protocol layers will depend on the particulars of the specific embodiment.

While the embodiment of FIG. 1 is depicted using RF transmission, it will be further appreciated that embodiments of the present invention are capable of utilizing any method of wireless transmission including, without limitation, infrared, microwave and all ranges of the electromagnetic spectrum, sound wave communication, laser and all other optical communication methods, as well as inductive, capacitive and all other forms of electromagnetic effect communication. Nor are the embodiments of the present invention limited to simulating wireless communication using two testers. Some embodiments incorporate the functionality of bother tester 120 and tester 130 into a single multi-functional tester capable of communication with multiple devices.

FIG. 2 is an illustration of a protocol layer transmission rate analysis provided by one embodiment of the present invention. In the embodiment of FIG. 2, source device 110 of FIG. 1 is a cellular telephone that is capable of capturing video data. The protocol layers 111-117 are the example protocol layers that could be used by device 110 to pass video data from an application to RF transmission to tester 120. Each of these protocol layers may be effected differently by the factors and conditions present during transmission, and thus pass the video data through at different levels of efficiency. Analysis modules 121 and 131 of FIG. 1 are capable of measuring, in real time, the data transmission rate of each protocol layer 111-117, and Graph 221 is an example of how analysis modules 121 or 131 may present those measurements to a user. FIG. 2 depicts one moment in time of such real time measurements.

Graph 221 may be in the form of a graphic user interface (GUI) and displayed on a monitor in communication with tester 120. In the embodiment depicted, graph 220 represents the real time data transfer rates of layers 111-117 as bars 211-217 corresponding to the percentage of successful frame transmission through each protocol layer. For example, at the moment in time captured by FIG. 2, RF layer 117 is successfully passing 80% of the video frames passed to it by MAC layer 216. In contrast, SNDCP layer 113 is only successfully passing 40% of the frames passed to it by IP/X.25 layer 112. While traditional methods provide a real time frame rate for the entire stack, the conditions present may cause each layer to pass data at different success rates. Graph 221, therefore, provides a device designer with a deeper understanding of how each protocol layer is processing the data.

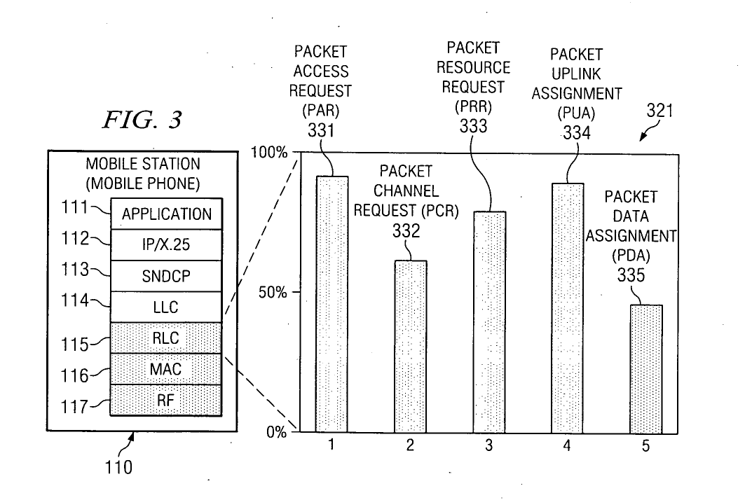

FIG. 3 is an illustration of a more detailed analysis of a single protocol layer. Some embodiments provide the increased functionality of breaking down the performance of a single protocol layer's individual aspects. In the embodiment of FIG. 3, analysis module 120 (from FIG. 1) is capable of measuring the frame rates for the different aspects of RLC layer 115, which is providing a reliable radio link between mobile device 110 and the simulated portions of the BSS by performing segmentation/re-assembly on data packets and controlling the coding schemes used on those packets. The analysis of these aspects is detailed in graph 321. As with graph 221 (from FIG. 2) graph 321 may be displayed on a monitor in communication with analysis module 120 or 131 and as part of a GUI. In graph 221, the data rates for the separate aspects of RLC layer 115 are displayed as bars representing a percentage of frames that are successfully processed. In the depicted example, Packet Access Request (PAR) aspect 331 represents mobile device 110 requesting access to the network. At the moment in time captured, PAR is successfully processing 90% of the frames passed to it. Packet Channel Request (PCR) aspect 332 represents mobile device 110 requesting an uplink channel. At the moment in time captured, PCR 332 is successfully processing 60% of the frames passed to it. Packet Resource Request (PRR) 333 represents mobile device 110 requesting uplink resources. At the moment in time captured, PRR 333 is successfully processing 75% of the frames passed to it. Packet Uplink Assignment (PUA) aspect 334 represents mobile device in an uplink transmission. In the moment in time captured, PUA 334 is successfully processing 90% of the frames passed to it. Packet Downlink Assignment (PDA) aspect 335 represents mobile device in a downlink transmission. In the moment in time captured, PDA 335 is successfully processing 50% of the frames passed to it. Each of the protocol layer aspects 331-335 will react to different conditions that may be present during transmission. For example, a bad signal at mobile device 110 will cause PUA to go down, whereas a bad signal at the tester will cause PDA 335 to go down. Being able to analyze the successful processing rates for each aspect of a given protocol allows a designer to more effectively investigate the performance of a mobile device.

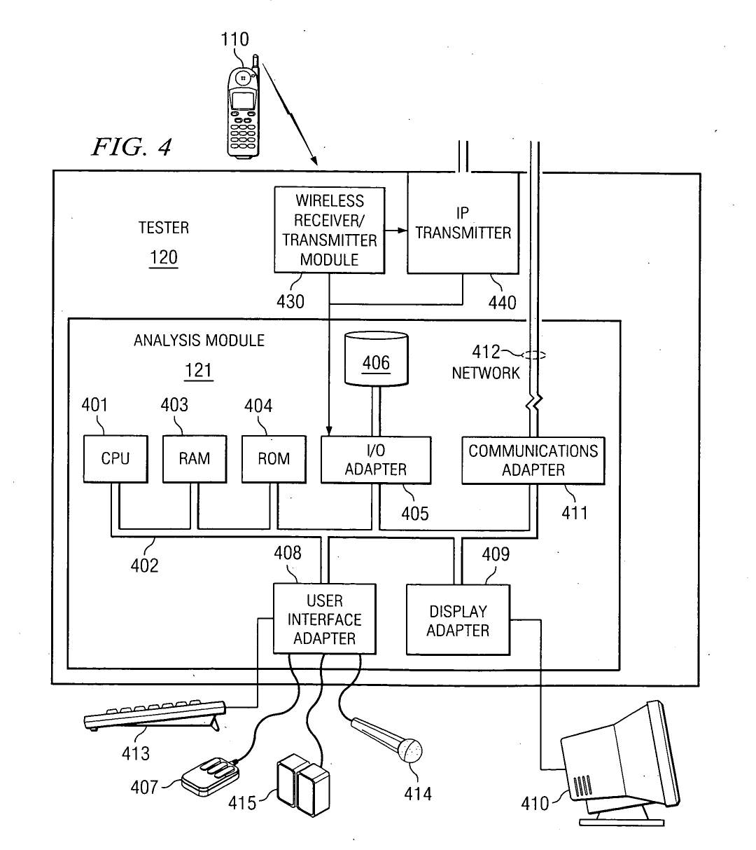

FIG. 4 illustrates an example tester arranged according to one embodiment of the present invention. Tester 120 receives and transmits data using wireless receiver/transmitter module 430. As described previously, embodiments of the present invention may utilize any form of wireless communication, thus wireless module 430 may be capable of receiving and transmitting, without limitation, infrared, microwave and all ranges of the electromagnetic spectrum, sound wave communication, laser and all other optical communication methods, as well as inductive, capacitive and all other forms of electromagnetic effect communication. The data received by module 430 is passed to IP transmit module 440 where it is reformatted for transmission to a destination tester using an IP format.

Tester 120 may further include analysis module 121, which is adapted according to one embodiment of the present invention. When implemented via computer-executable instructions, various elements of analysis module 121 are the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like), or communicated via a data signal from a communication medium (e.g., the Internet). In fact, readable media can include any medium that can store or transfer information.

Analysis module 121 comprises an example system on which embodiments of the present invention may be implemented (such as a GUI that includes graph 221 of FIG. 2 and/or a GUI that includes graph 321 of FIG. 3). Central processing unit (CPU) 401 is coupled to system bus 402. CPU 401 may be any general purpose CPU. A suitable processors may include without limitation INTEL's PENTIUM® 4 processor, as an example. However, the present invention is not restricted by the architecture of CPU 401 as long as CPU 401 supports the inventive operations as described herein. CPU 401 may execute the various logical instructions according to embodiments of the present invention. For example, CPU 401 may execute machine-level instructions that facilitate the measuring of frame rate throughput as depicted in FIGS. 1, 2, and 3.

Analysis module 121 also may include random access memory (RAM) 403, which may be SRAM, DRAM, SDRAM, or the like. Analysis module 121 may includes read-only memory (ROM) 404 which may be PROM, EPROM, EEPROM, or the like. RAM 403 and ROM 404 hold user and system data and programs, as is well known in the art.

Analysis module may also include input/output (I/O) adapter 405, communications adapter 411, user interface adapter 408, and display adapter 409. I/O adapter 405, user interface adapter 408, and/or communications adapter 411 may, in certain embodiments, enable a user to interact with computer system 400 in order to input information, such as display parameters for the data rate measurements.

I/O adapter 405 communicatively connects analysis module 121 to wireless module 430 and IP transmission module 440. This connection provides the input from which the measurements are extracted. Alternatively. I/O adapter may be connected to a mobile device using a direct connection that provides the protocol stack measurements. I/O adapter 405 also connects to storage device(s) 406, such as one or more of hard drive, compact disc (CD) drive, floppy disk drive, tape drive, etc. analysis module 121. The storage devices may be utilized when RAM 403 is insufficient for the memory requirements associated with storing the measurements taken during the testing of mobile devices. Communications adapter 411 is preferably adapted to couple tester 120 to network 412 used, for example, to control or monitor a plurality of testers. User interface adapter 408 couples user input devices, such as keyboard 413, pointing device 407, and microphone 414 and/or output devices, such as speaker(s) 415 to analysis module 121. Display adapter 409 is driven by CPU 401 to control the display on display device 410 to, for example, display the user interface (such as a GUI that includes graph 221 of FIG. 2 and/or a GUI that includes graph 321 of FIG. 3) of embodiments of the present invention.

It shall be appreciated that the present invention is not limited to the architecture of system 400. For example, any suitable processor-based device may be utilized, including without limitation personal computers, laptop computers, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of testing wireless device data transfer, said method comprising:
transferring data through a plurality of protocol layers used by said device; and
testing said transfer by measuring at least one performance characteristic of two or more of said protocol layers.

2. The method of claim 1 further comprising:
measuring a rate said data is successfully transferred by said at least one of said protocol layers.

3. The method of claim 1 further comprising:
simulating a wireless network with a tester in communication with said device, wherein said tester measures said at least one performance characteristic.

4. The method of claim 3 further comprising:
simulating a plurality of wireless networks with said tester.

5. The method of claim 3 further comprising:
simulating another wireless network with a second tester in communication with a second device, wherein said second tester measures at least one performance characteristic of at least one protocol layer of said second device; and
transmitting data between said tester and said second tester via an internet protocol, whereby said data is transmitted between said device and said second device.

6. The method of claim 1 further comprising:
displaying said measurements in real time via a graphic user interface.

7. The method of claim 1 further comprising:
measuring a performance characteristic of a plurality of aspects of said at least one of said protocol layers.

8. The method of claim 7, wherein said at least one protocol layer is a radio link control layer.

9. A system for testing a wireless device, said system comprising:
data captured by said wireless device, wherein said data passes through at least two protocol layers and is transmitted; and
a tester receiving said transmission, wherein said tester measures the performance of said at least two protocol layers.

10. The system of claim 9 wherein said tester transmits said data to a network.

11. The system of claim 9 further comprising:
an additional tester in communication with said tester and receiving a transmission for an additional wireless device, whereby data is transferred between said wireless device and additional wireless device.

12. The system of claim 11 wherein said tester communicates with said additional tester via an internet protocol.

13. The system of claim 9 further comprising:
a graphic user interface displaying said measurement in real time.

14. The system of claim 9, wherein said performance is a successful data transmission rate.

15. The system of claim 9, wherein said data is video data captured by a cellular telephone application.

16. The system of claim 15, wherein said protocol layer is a sub network dependent convergence protocol layer.

17. The system of claim 9 further comprising:
measuring a successful data transfer rate for each of a plurality of aspects of said protocol layer.

18. The system of claim 17, wherein said aspects include uplink transmission and downlink transmission.

19. A tester for testing a wireless device data transfer, said tester comprising:
a means for receiving data from said device, wherein said data passes through at least two protocol layers resident on said device;
a means of measuring data transfer rates of said at least two protocol layers; and
a means of producing a graphic user interface displaying at least one of said data transfer rates.

20. The tester of claim 19 wherein said data transfer rate is displayed in real time.

21. The tester of claim 19, wherein said data is wirelessly transferred to said device.

22. The tester of claim 19 further comprising:
a transmitter operable to transmit said data via an internet protocol.

23. The tester of claim 22 further comprising:
a receiver receiving return data in an internet protocol; and
an antenna transmitting said return data to said device.

24. The tester of claim 19 further comprising:
a processor analyzing said data to determine said data transfer rate.
